(19) United States
(12) Patent Application Publication
(10) Pub. No.: US 2019/0188518 A1
(43) Pub. Date: Jun. 20, 2019

(54) IMAGE PROCESSING CIRCUIT AND ASSOCIATED IMAGE PROCESSING METHOD

(71) Applicant: MStar Semiconductor, Inc., Hsinchu Hsien (TW)

(72) Inventor: Hui-Chih Lin, Hsinchu County (TW)

(21) Appl. No.: 15/969,219

(22) Filed: May 2, 2018

(30) Foreign Application Priority Data
Dec. 15, 2017 (TW) 106144069

(51) Int. Cl. G06K 9/46; G06T 7/90; G06T 7/11; G06T 7/00

(52) U.S. Cl. CPC G06K 9/4652; G06T 7/90; G06T 2207/10024; G06T 7/0002; G06T 7/11

(57) ABSTRACT

An image processing circuit includes a determining circuit, a converting circuit and a color removing circuit. The determining circuit determines a specific color that is different from all colors in a palette table. The converting circuit, coupled to the determining circuit, converts a first image in a palette mode to a second image having a color space according to the palette table, wherein a pixel having a specific index in the first image is converted to a pixel having the specific color. The color removing circuit, coupled to the converting circuit, removes the specific color from the second image.

This application claims the benefit of Taiwan application Serial No. 106144069, filed Dec. 15, 2017, the subject matter of which is incorporated herein by reference.

### BACKGROUND OF THE INVENTION

### Field of the Invention

The invention relates in general to image processing, and more particularly to an image processing circuit capable of color removal and an associated image processing method.

### Description of the Related Art

Palette coding technologies are extensively applied for coding images. One main concept of palette coding technologies is that, the color of each pixel is represented by an index. When a display device is to display images, a palette table is involved to convert these indices to image data coded in another color space (e.g., an RGB color space) and corresponding images are then displayed. In the prior art, a color removal (also referred to as “a key index”) function is supported by images coded by palette coding technologies; that is, a user can remove the color corresponding to an index through inputting the index.

FIG. 1 shows a schematic diagram of an image processing circuit 100 of the prior art. As shown in FIG. 1, the image processing circuit 100 includes a converting circuit 110, a scaling circuit 120 and a color converting circuit 130. The image processing circuit 100 is coupled to a memory 150, which stores a palette table. In the operation of the image processing circuit 100, the converting circuit 110 first receives a first image D1, in which the color of each pixel in the first image D1 is represented by an index. The converting circuit 110 converts the first image D1 to a second image D2. More specifically, the converting circuit 110 converts indices in the first image D1 into colors to generate the second image D2. The scaling circuit 120 scales the second image D2 to generate a scaled second image D2′. The color removing circuit 130 receives a color removal instruction Iy, obtains a color Cy indicated by the color removal instruction Iy from the memory 150, and removes the color Cy from the scaled second image D2′ to generate an output image D2″.

For example, assume that the color corresponding to an index “10” is orange (e.g., red, green and blue components in a color space are respectively (R1, G1, B1)). If a user-inputted color removal instruction Iy is asks to remove the color having the index “10”, the color removing circuit 130 identifies the color Cy corresponding to the index “10” from the memory 150, and directly replaces the color of pixels having the red, green and blue components (R1, G1, B1) to black. However, when the image processing circuit 100 needs to magnify the image, because an image magnification operation involves interpolation, it is possible that colors of new pixels generated by interpolation coincide with the above color having the red, green and blue components (R1, G1, B1). At this point, if a user happens to input a color removal instruction asking to remove the color of the index “10”, these pixels generated by interpolation may be replaced by black, thus affecting the display quality.

### SUMMARY OF THE INVENTION

Therefore, it is an object of the present invention to provide an image processing method capable of preventing an error caused by the above color removal operation so as to maintain display quality.

In one embodiment of the present invention, an image processing circuit includes a determining circuit, a converting circuit and a color removing circuit. The determining circuit determines a specific color different from all colors in a palette table. The converting circuit converts a first image in a palette mode to a second image having a color space according to the palette table, wherein a pixel having a specific index in the first image is converted to a pixel having the specific color. The color removing circuit removes the specific color from the second image.

In another embodiment of the present invention, an image processing method applied to an image processing circuit, includes: determining a specific color different from all colors in a palette table; converting a first image in a palette mode to a second image having a color space according to the palette table, wherein a pixel having a specific index in the first image is converted to a pixel having the specific color; and removing the specific color from the second image.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 is a schematic diagram of an image processing circuit of the prior art;

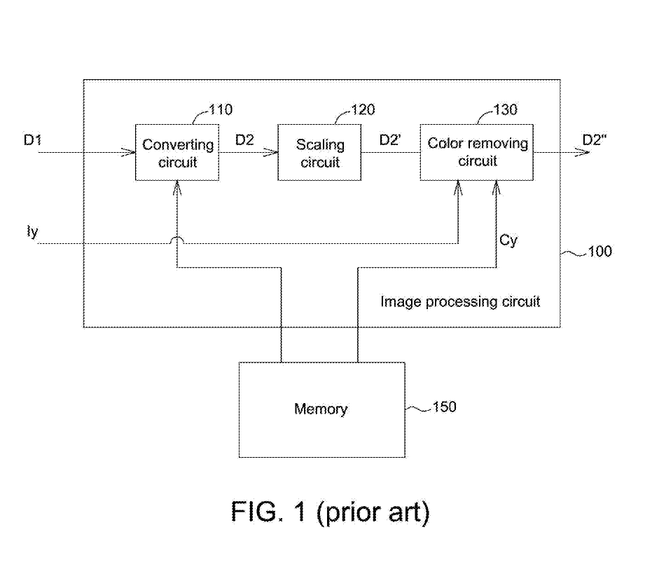

FIG. 2 is a schematic diagram of an image processing circuit according to an embodiment of the present invention;

FIG. 3 is a flowchart of an image processing method according to an embodiment of the present invention;

FIG. 4 is a schematic diagram of an RGB color space; and

FIG. 5 is a schematic diagram of a color space divided into multiple regions and colors recorded in a palette table in a color space.

### DETAILED DESCRIPTION OF THE INVENTION

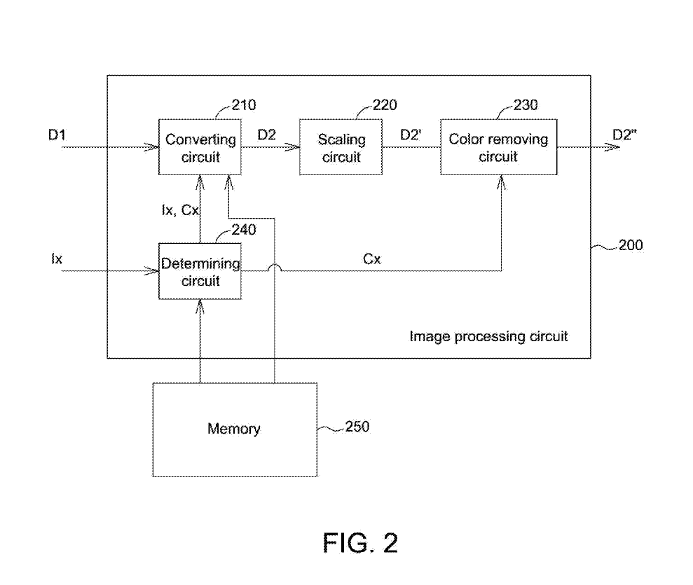

FIG. 2 shows a schematic diagram of an image processing circuit 200 according to an embodiment of the present invention. As shown in FIG. 2, the image processing circuit 200 includes a converting circuit 210, a scaling circuit 220, a color converting circuit 230 and a determining circuit 240. The image processing circuit 200 is coupled to a memory 250, which stores a palette table. In this embodiment, the image processing circuit 200 is provided in a television or a set-top box (STB), and receives a first image D1 encoded according to palette coding technologies so as to generate an output image D2″ to be displayed by a display panel or to be further processed by a back-end circuit.

In the image processing circuit 200, the converting circuit 210 converts indices to colors. More specifically, the converting circuit 210 first receives a first image D1, in which a color of each pixel in the first image D1 is represented by an index and the color corresponding to each index is stored in a palette table in the memory 250. The converting circuit 210 reads the palette table from the memory 250, converts the index of each pixel in the first image to a corresponding color according to the palette table, and accordingly generates a second image D2. For example, the palette table may record indices and the corresponding colors. The term “color” refers to a composition of a red component, a green component and a blue component in an RGB color space, and the red/green/blue component can be represented by a value between 0 and 25. The converting circuit 210 converts the index corresponding to each color in the first image D1 to the corresponding color in the palette table according to the palette table.

The scaling circuit 220 scales the second image D2 to generate a scaled second image D2′. In this embodiment, the scaling circuit 220 performs a magnification operation on the second image D2, e.g., magnifying the second image D2 from an original a resolution of 19201080 to a resolution of 3840*2160. It should be noted that, because new pixels are generated during the magnification process performed on the second image D2, interpolation is needed to acquire colors of these new pixels; however, pixel values (i.e., colors) generated by the interpolation may coincidently correspond to the color corresponding to one of the indices recorded in the palette table.

The color removing circuit 230 removes a specific color from the scaled second image D2′ according to a color removal instruction to generate an output image D2″. If the color removal instruction is not received, the color removing circuit 230 is not required to process the scaled second image D2′; that is, the scaled second image D2′ may directly serve as the output image D2″. More specifically, the color removal instruction indicates a specific index Ix, and the color removing circuit 230 removes the color corresponding to the specific index Ix from the scaled second image D2′, i.e., adjusting the pixel(s) having the color to black. For example, assuming that a user-inputted color removal instruction asks to remove the color corresponding to the index “15”, the color removing circuit 230 then adjusts the color corresponding to the index “15” in the scaled second image D2′ to black. However, as previously described, pixel values (i.e., colors) generated by the interpolation during the magnification process performed on the second image D2 may coincide with the color corresponding to the index “15”. Thus, the color removing circuit 230 would incorrectly adjust the pixel values generated by the interpolation to black, causing a flaw in the display image.

To solve the above issue, the image processing circuit 200 further includes a determining circuit 240 for determining a specific color Cx corresponding to the specific index Ix. The specific color Cx includes a specific red component, a specific green component and a specific blue component (Rx, Gx, Bx). When the image processing circuit 200 receives a color removal instruction asking to remove the color having the specific index Ix, the determining circuit 240 first calculates a specific color Cx different from all of the colors in the palette table, provides the specific index Ix and the specific color Cx to the converting circuit 210, and provides the specific color Cx to the color removing circuit 230. At this point, the converting circuit 210 directly converts the pixel having the specific index Ix in the first image D1 to the specific color Cx; that is, for this specific index, the converting circuit 210 does not determine the color corresponding to the specific index according to the palette table, and the color removing circuit 230 adjusts the pixel having the specific color Cx in the scaled second image D2′ to black, and does not remove the color having the specific index recorded in the palette table. For example, assume that the color removal instruction asks to remove the color corresponding to the index “15” (e.g., scarlet). At this point, the determining circuit 240 determines a specific color (e.g., pale yellow) different from all the colors in the palette table, the converting circuit 210 converts all pixels having the index “15” in the first image D1 to the specific color (pale yellow), and the color removing circuit 230 removes only pale yellow from the scaled second image D2′. Thus, the above issue of removing the color of pixels generated by interpolation can be effectively prevented.

In the embodiment in FIG. 2, the specific index Ix is transmitted to the converting circuit 210 through the determining circuit 240. However, in another embodiment of the present invention, because the decision for the specific color does not involve the specific index Ix, the specific index Ix may be directly inputted to the converting circuit, 210, and the determining circuit 240 only needs to transmit the specific color Cx to the converting circuit 210.

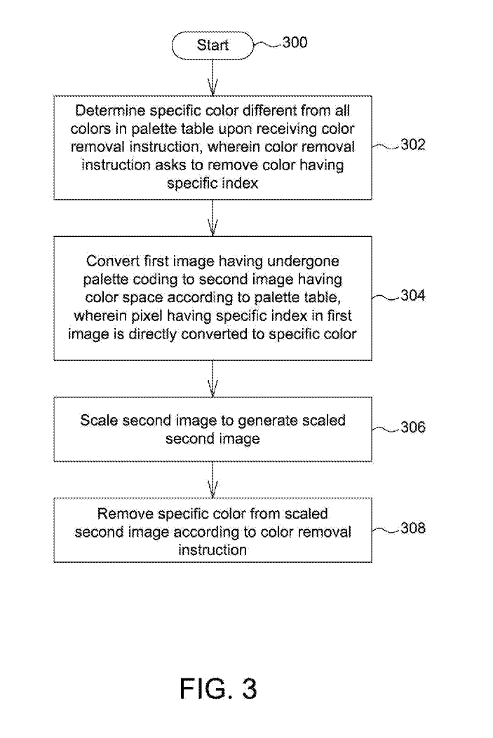

FIG. 3 shows a flowchart of an image processing method according to an embodiment of the present invention. Also referring to FIG. 2 and the above disclosure, a process of the image processing method includes following steps.

In step 300, the process begins.

In step 302, when a color removal instruction is received, a specific color different from all colors in a palette table is determined, wherein the color removal instruction asks to remove a color having a specific index.

In step 304, a first image in a palette mode is converted to a second image having a color space according to the palette table, wherein a pixel having the specific index in the first image is directly converted to having the specific color.

In step 306, the second image is scaled to generate a scaled second image.

In step 308, the specific color is removed from the scaled second image according to the color removal instruction.

In the flowchart of the image processing method according to an embodiment of the present invention in FIG. 3, step S302 determines the specific color upon receiving a color removal instruction. However, in another embodiment, the determining circuit 240 may determine, instead of having to wait till the color removal instruction is received, the specific color according to the content of the palette table in advance.

In the above embodiment, the specific color determined is different from all the colors in the palette table. However, it is still possible that the specific color (pale yellow) in the above embodiment is the color of pixels generated by interpolation. Thus, to minimize such possibility and considering that interpolation is generally used for situations where neighboring colors are similar, a method is further provided according to another embodiment of the present invention to cause the specific color determined by the determining circuit 240 to have a predetermined color scale distance from the colors recorded in the palette table.

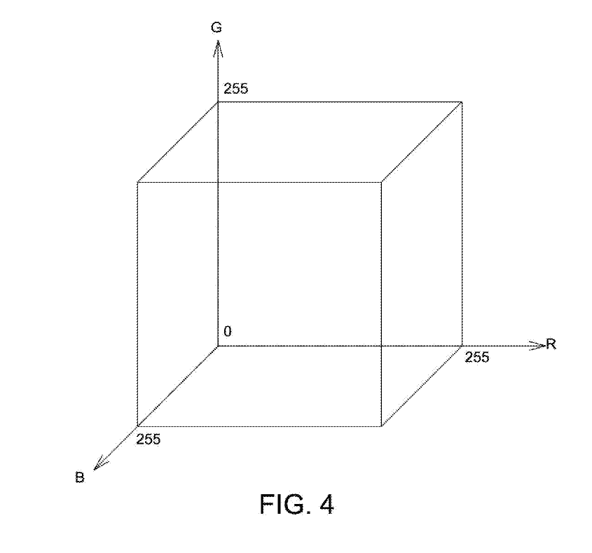

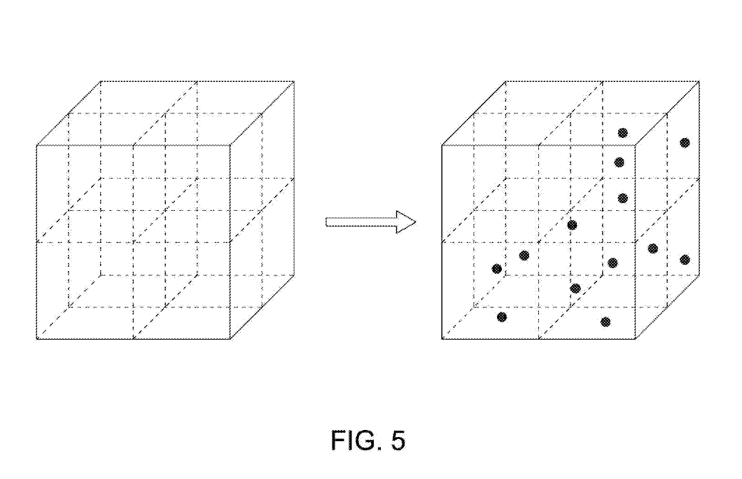

FIG. 4 shows an RGB color space. In FIG. 4, values of the red component (R), green component (G) and blue component (B) are all between 0 and 255; that is, through different red/green/blue combinations, 256*256*256 colors may be generated. In this embodiment, the determining circuit 240 divides the entire color space shown in FIG. 4 into multiple regions. In this embodiment, considering that the palette table has 256 indices/colors, the determining circuit 240 divides each of the red component (R), the green component (G) and the blue component (B) in FIG. 3 into eight sections; that is, the entire color space is divided into 512 (8*8*8=512) cubic regions, each of which includes 32*32*32 colors. For simplicity, FIG. 5 depicts only eight regions for further description.

The determining circuit 240 first sets a tag for each cubic region. The tag has a default value, e.g., logic “0”. The determining circuit 240 then reads the palette table from the memory 250, and modifies the tag of the cubic region corresponding to the colors recorded in the palette table to logic “1”. For example, black dots in FIG. 5 represent colors recorded in the palette table, and the tags of the cubic regions having the black dots are set to logic “1”, whereas the tags of cubic regions without the black dots (e.g., two regions are the upper left corner) are kept at logic “0”.

The determining circuit 240 may select any desired cubic region of which the tag is logic “0” as a specific region, select the specific color from the specific region, and provide the selected specific color to the converting circuit 210 and the color removing circuit 230. In one embodiment, to ensure that the specific color is spaced from the colors recorded in the palette table by a predetermined color scale distance, the determining circuit 240 uses the color at a center of the specific region as the specific color, so as to ensure that the red component (R), the green component (G) and the blue component (B) of the specific color are spaced from the colors recorded in the palette table by a color scale distance “16”. Further, when the determining circuit 240 cannot find any cubic region of which the tag is logic “0”, the color space needs to be again divided into more cubic regions (e.g., 4096 (16*16*16=4096), and the logic values of the tags need to be again set.

Since the color space is divided in advance instead of sequentially comparing all possible repeating colors one after another, the operation of the above determining circuit 240 can quickly determine the specific color by using minimal hardware/software resources. Further, the specific color is spaced from the colors recorded in the palette table by a certain color scale distance, such that the possibility that the specific color is identical to the color of any new pixels generated by interpolation performed by the scaling circuit 220 is minimized (minimal possibility). Particularly, as the number of regions divided for the entire color space gets smaller, the less hardware/software resources are needed, and the specific color determined is necessarily spaced from the colors recorded in the palette table by a larger color scale distance.

In conclusion, in the image processing circuit and the associated method, the determining circuit determines a specific color spaced from all the colors in a palette table by a certain color scale distance, and provides this specific color for further use to the converting circuit and the color removing circuit, wherein the specific color is used to replace a color asked to be removed according to a user-inputted color removal instruction. With the present invention, the issue of incorrectly removing a color of pixels generated by interpolation is solved, and the associated operation can be completed by using few steps and minimal hardware resources.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An image processing circuit, comprising:
a determining circuit, determining a specific color different from all colors in a palette table;
a converting circuit, converting a first image in a palette mode to a second image having a color space according to the palette table, wherein a pixel having a specific index in the first image is converted to a pixel having the specific color; and
a color removing circuit, removing the specific color from the second image.

2. The image processing circuit according to claim 1, further comprising:
a scaling circuit, coupled between the converting circuit and the color removing circuit, scaling the second image to generate a scaled second image;
wherein, the color removing circuit removes the specific color from the scaled second image.

3. The image processing circuit according to claim 1, wherein the determining circuit divides the color space into a plurality of regions and selects one specific region from the regions, the specific color does not include any color corresponding to the palette table, and the determining circuit further determines the specific color from the specific region.

4. The image processing circuit according to claim 3, wherein the determining circuit determines a color corresponding to a center of the specific region as the specific color.

5. The image processing circuit according to claim 3, wherein a quantity of the regions is greater than a quantity of all indices in the palette table.

6. The image processing circuit according to claim 3, wherein when each of the regions includes at least one of the colors corresponding to the palette table, the determining circuit again divides the color space into a greater number of regions.

7. The image processing circuit according to claim 3, wherein the color space is an RGB color space, and the determining circuit divides the color space into a plurality of cubic regions.

8. The image processing circuit according to claim 3, wherein each of the regions corresponds to a tag, the determining circuit sets the tags of a part of the regions, wherein the part of the regions comprise the colors corresponding to the palette table, and the determining circuit selects from the regions a region of which the tag is not yet set as the specific region.

9. The image processing circuit according to claim 1, disposed in a television or a set-top box (STB).

10. An image processing method, applied to an image processing circuit, comprising:
determining a specific color different from all colors in a palette table;
converting a first image in a palette mode to a second image having a color space according to the palette table, wherein a pixel having a specific index in the first image is converted to a pixel having the specific color; and
removing the specific color from the second image.

11. The image processing method according to claim 10, further comprising:
scaling the second image to generate a scaled second image;
wherein, the step of removing the specific color from the second image removes the specific color from the scaled second image.

12. The image processing method according to claim 10, wherein the step of determining the specific color different from all of the colors in the palette table comprises:
dividing the color space into a plurality of regions;
selecting one specific region from the regions, wherein the specific color does not include any color corresponding to the palette table; and
determining the specific color from the specific region.

13. The image processing method according to claim 12, wherein the step of determining the specific color determines a color corresponding to a center of the specific region as the specific color.

14. The image processing method according to claim 12, wherein a quantity of the regions is greater than a quantity of all indices in the palette table.

15. The image processing method according to claim 12, wherein when each of the regions includes at least one of the colors corresponding to the palette table, the color space is again divided into a greater number of regions.

16. The image processing method according to claim 12, wherein the color space is an RGB color space, and the step of dividing the color space into the regions divides the color space into a plurality of cubic regions.

17. The image processing method according to claim 12, wherein each of the regions corresponds to a tag, and the step of selecting the specific region from the regions comprises:
setting the tags of a part of the regions, wherein the part of the regions comprise the colors corresponding to the palette table; and
selecting from the regions a region of which the tag is not yet set as the specific region.

18. The image processing method according to claim 10, applied in a television or a set-top box (STB).
